(19) United States
(12) Patent Application Publication
(10) Pub. No.: US 2012/0031545 A1
(43) Pub. Date: Feb. 9, 2012

(54) Customizable Financial Transaction Instrument

(75) Inventors: Shawn Vaccaro, Draper, UT (US); Ted Jones, Draper, UT (US)

(73) Assignee: Critical Systems, Inc., Draper, UT (US)

(21) Appl. No.: 13/016,931

(22) Filed: Jan. 28, 2011

Related U.S. Application Data
(60) Provisional application No. 61/299,261, filed on Jan. 28, 2010.

(51) Int. Cl. B65C 9/26; B32B 38/14

(52) U.S. Cl. 156/153; 156/387; 156/277

(57) ABSTRACT

Disclosed is a system for customizing a gift card. The system includes a indicia carrier having a machine readable medium for an encoded account number supported on one side of the indicia carrier and being devoid of embossed account indicia on an opposite side. The system also includes a self-adhesive label adapted for application onto at least part of a surface of the indicia carrier. The system further includes means for customizing the label with a customized display. The system also includes a printer to print the customized display on the label. Additionally, the system includes a label applicator that facilitates alignment of the label with the indicia carrier for joining the label and the indicia carrier.

### CROSS REFERENCE TO RELATED APPLICATIONS

This application claims the benefit of U.S. Provisional Patent Application Ser. No. 61/299,261, filed Jan. 28, 2010, and entitled, “Customizable Financial Transaction Instrument,” which is incorporated by reference herein in its entirety.

### FIELD OF THE INVENTION

The present invention relates generally to financial transaction instruments, such as gift cards, and more particularly to gift cards capable of being customized or personalized at home or at a point of sale.

### BACKGROUND OF THE INVENTION AND RELATED ART

Financial transaction instruments, such as gift cards, have become a popular form of gift, in part because of the benefits and flexibility they provide to both the recipient and the giver. The recipient has the freedom to redeem the gift card for particular items of his or her choice, which has many advantages, such as helping to avoid the awkwardness and hassle of returning unwanted gifts. Gift cards are also convenient for the giver because the giver may not have time to shop for a particular gift, the giver will naturally experience less pressure in finding a gift he/she thinks the intended recipient might like, particularly if the recipient has tastes that are hard to discern. And, it allows the giver to avoid giving cash, which is often considered a thoughtless gift. Thus, for many people, gift cards provide a solution to the sometimes worrisome problem of determining what gift to give someone.

To enhance their appeal, gift cards may include graphical displays that commemorate a particular event, time of year, or holiday. Some gift cards, however, are only offered in a limited number of designs. Other gift cards may have many design options, or they may even be customizable by a buyer, but they are not available at retail outlets. Thus, the buyer must order a gift card and wait days or weeks for it to be processed and shipped before the gift card can be used or given as a gift. Or, a buyer must locate a dedicated gift card station or kiosk in one or more specific locations, and visit that station in person to undertake the gift card generation process. Any personal items needed to customize the gift card (e.g., a flash drive having one or more photos or graphics stored thereon) must be physically brought to the location of the dedicated station and caused to interface with the supported system.

### SUMMARY OF THE INVENTION

In light of the problems and deficiencies inherent in the prior art, the present invention seeks to overcome these by providing a gift card that is customizable and available for immediate use upon the gift card's creation. Moreover, the gift card may be created at a time and location that is convenient to the user.

In accordance with the invention as embodied and broadly described herein, the present invention resides in a system for customizing a gift card. The system can comprise a indicia carrier having a machine readable medium for an encoded account number supported on one side of the indicia carrier and being devoid of embossed account indicia on an opposite side. The system can further comprise a self-adhesive label adapted for application onto at least part of a surface of the indicia carrier. The system can still further comprise means for customizing the label with a customized display. The system can also comprise a printer to print the customized display on the label. Additionally, the system can comprise a label applicator that facilitates alignment of the label with the indicia carrier for more precise application of the label to the indicia carrier, thus reducing the chance for overhang of the label with respect to the edges of the indicia carrier, and the potential for the label to peel away from the indicia carrier and adversely affecting card readers or point of sale equipment.

In one aspect, the present invention system contemplates a heat source used to apply heat to the label and/or the indicia carrier to improve adhesion of the label to the indicia carrier. In another aspect, the present invention contemplates an abrader used to abrade a surface of the indicia carrier to improve subsequent adhesion of the label to the indicia carrier. The heat source and/or the abrader may be contained and supported and operative within the label applicator.

A method for facilitating the creation of a customized gift card is also provided. The method can comprise making available a indicia carrier having a machine readable medium for an encoded account number supported on one side of the indicia carrier and being devoid of embossed account indicia on an opposite side. The method can further comprise making available a label to be applied to the indicia carrier. The method can still further comprise facilitating customization of the label to comprise a customized display. The method can also comprise facilitating printing of the customized display on the label. Additionally, the method can comprise facilitating application of the label to the indicia carrier.

In one aspect, the making available a indicia carrier, the making available a label occurs, the facilitating customizing of the label, the facilitating printing, and the facilitating application of the label to the indicia carrier all occur or are carried out at a point of sale. In another aspect, one or more of these can be carried out at a point of sale and/or at a post-point of sale location, such as at a home or office.

The method further comprises facilitating alignment of the label with the indicia carrier during the application of the label to the indicia carrier. In a particular aspect, facilitating alignment comprises providing a label applicator having a guide or other constraint, such as a guide wall, for aligning an edge of the indicia carrier and an edge of the label to facilitate proper placement of the label on the indicia carrier. In a more particular aspect, the method further comprises disposing the label in the label applicator with an adhesive side of the label at least partially exposed, and disposing the indicia carrier in the label applicator to contact the adhesive side of the label.

In yet another aspect, the method further comprises applying heat to at least one of the label and the indicia carrier to improve adhesion of the label to the indicia carrier. In still another aspect, the method further comprises abrading at least a portion of a surface of the indicia carrier prior to receiving the label to improve adhesion of the label to the surface of the indicia carrier.

In still another aspect, facilitating customization of the label comprises providing network access to stored data, wherein the data may be retrieved to create at least a part of the customized image. In a particular aspect, the data is stored on and retrieved from an internet accessible database.

A method for creating a customized gift card is also provided, which comprises obtaining a indicia carrier having a machine readable medium for an encoded account number supported on one side of the indicia carrier and being devoid of embossed account indicia on an opposite side. The method can further comprise customizing a display for the indicia carrier. The method can also comprise printing the display on a label. Additionally, the method can comprise joining the label to the indicia carrier.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1A illustrates a gift card in accordance with an exemplary embodiment of the present invention;

FIG. 1B illustrates a gift card in accordance with another exemplary embodiment of the present invention;

FIG. 2A illustrates a front side of the indicia carrier of the gift card of FIG. 1A;

FIG. 2B illustrates a front side of the indicia carrier of the gift card of FIG. 1B;

FIG. 2C illustrates a back side of the indicia carrier of the gift card of FIG. 1A;

FIG. 3A illustrates a label of the gift card of FIG. 1A;

FIG. 3B illustrates a label of the gift card of FIG. 1B;

FIG. 4 illustrates the label of FIG. 3A being joined with the indicia carrier of FIG. 2A;

FIG. 5A illustrates a label applicator for a gift card in accordance with an exemplary embodiment of the present invention;

FIG. 5B illustrates a label applicator for a gift card in accordance with another exemplary embodiment of the present invention;

FIG. 6A illustrates the label applicator of FIG. 5A being used to join a label and an indicia carrier in accordance with an exemplary embodiment of the present invention;

FIG. 6B illustrates the label applicator of FIG. 5A being used to join a label and an indicia carrier in accordance with another exemplary embodiment of the present invention;

FIG. 6C further illustrates the label applicator of FIG. 5A being used to join a label and an indicia carrier in accordance with the embodiment of FIG. 6B;

FIG. 7 illustrates a system for generating a gift card in accordance with an exemplary embodiment of the present invention;

FIG. 8 illustrates a flow diagram of a process for preparing a gift card for use in accordance with an exemplary embodiment of the present invention;

FIG. 9 illustrates a flow diagram of a process for activating a gift card using a post point of sale activation system in accordance with an exemplary embodiment of the present invention;

FIG. 10 illustrates a flow diagram of a process for customizing a layout for a gift card in accordance with an exemplary embodiment of the present invention; and

FIG. 11 illustrates a flow diagram of a process for printing a label for a gift card in accordance with an exemplary embodiment of the present invention.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only to describe the features and characteristics of the present invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

The present invention describes a method and system for generating or creating a customized gift card, for facilitating the creation of a customized gift card, and generally preparing a customized gift card for use.

The present invention provides several significant advantages over prior related gift cards, some of which are recited here and throughout the following more detailed description. First, the gift card may be customized at a time and location chosen by a user, and in some embodiments made available for giving as a gift without delay. Second, the gift card may be customized in appearance and in the financial networks (including merchants) that recognize the gift card. Third, the gift card may be activated at a time that is post point of sale on a post point of sale activation system. Fourth, after the gift card has been activated, it may be refreshed with funds and its customizable aspects of appearance and financial networks may be modified.

The term gift card is generally intended to mean any monetary equivalent or scrip in which electronic authorization of available funds is utilized in one or more ways. For example, a gift card may be usable within an open loop, closed loop or hybrid closed loop type system.

The term indicia carrier is intended to mean the physical, tangible medium operable with an applied label, wherein the indicia carrier together with the label make up the physical elements of the gift card.

The term post point of sale activation system is intended to mean a supported system accessible by a user following a purchase of one or more indicia carriers (and optionally labels) for the purpose of activating an account associated with the one or more indicia carriers purchased at a point of sale, and for generating a usable gift card.

Each of the above-recited advantages will be apparent in light of the detailed description set forth below, with reference to the accompanying drawings. These advantages are not meant to be limiting in any way. Indeed, one skilled in the art will appreciate that other advantages may be realized, other than those specifically recited herein, upon practicing the present invention.

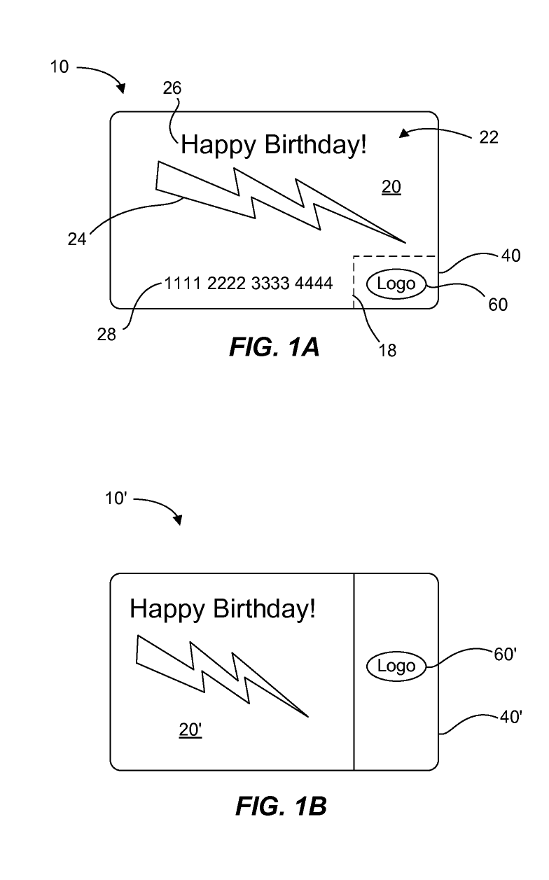

Referring to FIG. 1A, there is shown an illustrative gift card as provided for in accordance with one exemplary embodiment of the present invention. As illustrated in the figures, the gift card is in the form of a plastic card of a type similar to those known in the art in terms of it being a restricted monetary equivalent or scrip intended to be purchased by one for presentation as a gift to another, and which may be used for purchasing goods and/or services from a merchant or set of merchants. It is to be noted that while a gift card is shown for illustrative purposes, it is but one example of the numerous forms in which the gift card of the present invention may be realized in practice.

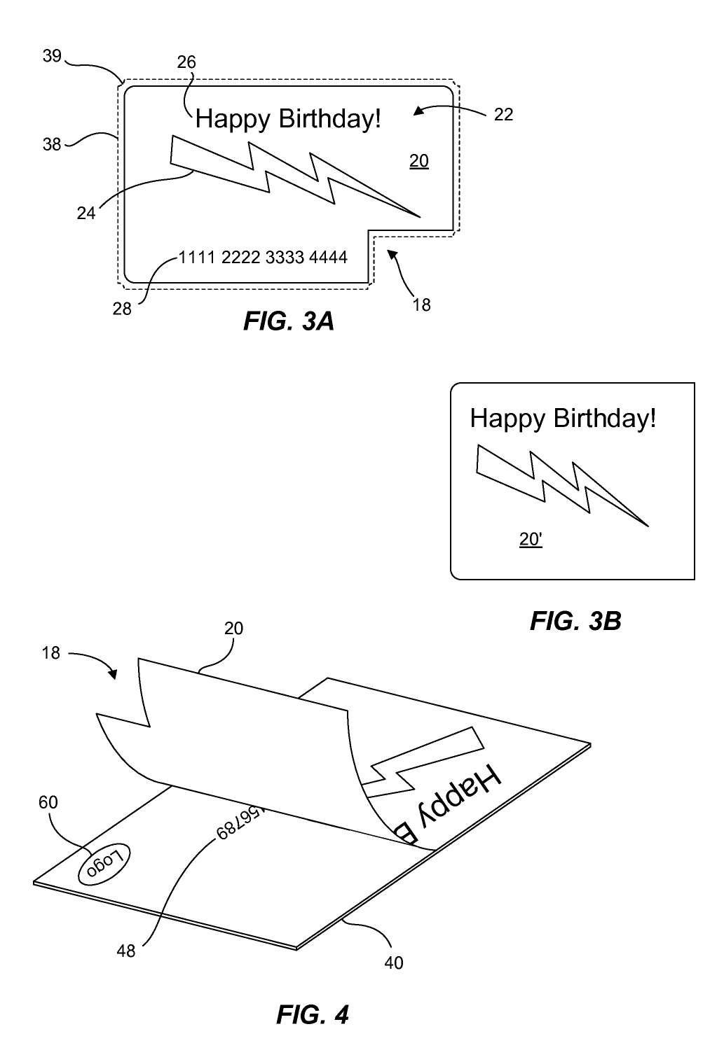

FIG. 1A is an illustration of the front side of the gift card 10. The gift card 10 may include an indicia carrier 40 (e.g., a physical plastic card) having a label 20 joined or affixed thereto. An account number may be visibly displayed on the label 20. A graphic arrangement 22 produced or customized by a user or predetermined by a participating merchant or system administrator may be printed on the label 20, as will be described further below. The graphic arrangement 22 on the label 20 may include a plurality of graphic elements provided by or obtained by a user, generated from a plurality of graphic tools, etc. as will be described in paragraphs that follow. It is to be understood that there is no limit on either the number or the type of graphic elements available for forming the graphical arrangement 22. The label 20 shown in the figure is illustrated as covering an entire front surface of the gift card 10. However, a gift card may include a label that does not cover the entire front surface, as indicated by optional notch or cut-out 18 (discussed in more detail below with reference to FIG. 3A).

As shown in FIG. 1A, label 20, and particularly the graphic arrangement 22, may comprise a graphic image or work of art 24. Graphic image 24 may be any image provided in a digital format. For example, a graphical image may be a photograph, such as one acquired via a digital camera or a scanned image of a hard copy photograph. In another example, graphic image 24 may include graphical art elements, such as clip art. The graphic arrangement 22 may further include design elements such as text 26, a decorative border (not shown), wallpaper images, watermarks, network or retail logos etc. Essentially, it is contemplated that the graphic arrangement 22 may comprise any visual indicia that may be produced, generated, reproduced, obtained, acquired, etc. and that is capable of being printed onto the label 20. In one exemplary embodiment, various graphical images, art, or other design elements may be acquired from a library of such stored in a database on a hard drive, and selectively utilized by a user to generate a customized graphic arrangement. Alternatively, such images, art, text, logos or other design elements (the graphical elements) may be stored on an external memory device such as a CD ROM and retrieved by a user via a disk reader.

FIG. 1B illustrates another example of a gift card 10′. This example illustrates a label 20′ that does not display any account indicia or information, such as an account number or card number. Such account information is, therefore, optional on a label of a gift card.

In certain aspects, the label can include an issue date and/or an expiration date, if applicable. In certain other aspects, the label can include a date on which the gift card was funded. In one example, this information can be printed on the label at the time of funding and activation of the gift card. Having this information visible on the gift card can benefit both gift card sellers and gift card buyers by making it easier to determine and know when the gift card will expire, particularly if it is desired that the expiration date be determined or set from the date of activation. The expiration date can be printed right onto the label to be applied to the card and at the time of activation. This may be increasingly important in light of government regulations that may mandate a certain length of time before a gift card can expire or before certain fees can be assessed. Such information can be printed on a label or on an indicia carrier, such as on a front side or a back side. In another aspect, the indicia carrier can come pre-printed with such information visible on a surface of the indicia carrier.

As will be discussed further below, certain embodiments of the present invention system and method may include customizing software for allowing a user to create a customized graphical arrangement on the gift card, such as that shown at 22 on the gift card 10. The customizing software may be installed on a user's computer or it may be available to the user over a computer network, such as the global computer network or global data communications system known as the internet. Customizing software may provide a set of utilities and/or drawing tools for creating a graphical element in the form of a digital graphic, such as the lightning bolt shown at 24, for acquiring user provided graphical elements (e.g., digital photos). Alternatively, an originally created drawing or other graphical element stored on an external memory device may be caused to be usable with the customizing software.

Certain embodiments of the customizing software may further include means to form a text message, such as the greeting shown at 26. The text authoring capability of the customizing software may include features known in the art such as type-face selection, font size selection and applying special effects to the text, such as warping. A language selection feature may also be included to allow for further customization of the label text.

As will be described further below, a user interface on the customizing software may allow a user to position the various graphical elements into a desired layout before printing to create the desired graphic arrangement 22 on the label 20 to be subsequently affixed to the indicia carrier 40. Thus, a user has the freedom to create an original design arrangement and, if desired, to convey a desired message. For example, the recipient of the particular gift card 10 shown in FIG. 1A will be reminded of the gift giver and the birthday gift whenever the recipient uses the gift card. Additionally, as will be discussed further below, certain embodiments may facilitate the gift card to be refreshed or reloaded (i.e., the monetary equivalent associated or available with the gift card may be renewed to the previous value or, even, a different value) and used multiple times. In so doing, the user or the recipient may perpetuate the gift card's use, allowing the customized gift card to be used long after the gift is initially given. It is also contemplated in some embodiments that the bearer of the gift card will be able to create a new graphic arrangement on a new label, and either replace the existing label or place the new label over the old one.

Whereas the example of FIG. 1A is illustrative of a personalized birthday message, it should be noted that countless other messages may be conveyed by the visual indicia present on the gift card. Moreover, it should be noted that the applicability of the present invention extends beyond a personal gift card and gift giving application to advertising, rewards and other applications of a personal or commercial nature.

In accordance with certain other aspects of the present invention, the gift card 10 may be a gift card with purchasing power, such as to make one or more purchases of goods and/or services provided by a merchant or set of merchants. As is well known, the bearer of the gift card need only present the instrument to a merchant in a transaction (or present an account number associated with the gift card to the merchant in a transaction), whereupon electronic authorization, such goods or services may be purchased. Electronic authorization or verification systems allow merchants to verify, in a few seconds, that the card is valid and the customer has sufficient funds available that are associated with the card to cover the purchase, allowing the verification to happen at the time of purchase. Thus, prearranged business relationships may exist between the vendor of the gift card, a bank or other financial institution, and the intended merchant or merchants. Such relationships are well known and the specifics of such are not described in detail herein. However, the present invention contemplates such relationships.

The current invention may utilize prior related card approval networks and processing practices that are well known to merchants and consumers, and commonly utilized in the retail and credit industries.

The customizable gift card may typically be prepared for use and presented for the purchase of goods and services as either an open loop or closed loop style of card. In a prior related technology, an open loop transaction instrument may display the logo of an issuer of credit (i.e., Visa®, American Express®, Master Card®, or Discover®) and may be accepted by any merchant that has an existing business relationship with that particular issuer to accept the issuer's cards as an approved form of payment. The processing of open loop credit, debit, or gift card transactions may typically involve authorization, clearing and settlement steps between a card association, card issuer, merchant, and the merchant's selected acquirer.

The authorization process may begin when the cardholder presents and uses the transaction instrument at an accepting merchant location. Data may be transmitted by the merchant, through its acquirer, to the card association and then on to the card issuer. In some instances, the issuer and association may be the same organization (i.e., American Express® or Discover Card®). The card issuer can be a credit card company or financial institution that holds deposited funds for a gift card transaction. Data may be typically read and sent by the merchant from the machine readable section of the transaction instrument through established card processing networks. Typically, most transaction data is sent electronically, but a few (smaller) merchants may still forward card data by taking a physical imprint of the transaction instrument and sending a physical receipt to their acquirer. The issuer may either grant or deny authorization for the amount of the transaction performed by the card holder. If the transaction is approved, the card association may collect the necessary data from the acquirer and forward the information to the issuer. The settlement process may occur when the card association debits the issuer for the amount of the transaction and credits the acquirer's account with the funds. The acquirer may then forward the final payment on to the merchant for the goods or services provided.

Likewise, in a prior related technology, a closed loop gift card may typically display the logo of a single merchant. In some embodiments, the instrument may also display an initial balance on the account associated with the card. This may indicate to the card holder and the merchant the limit the card may have to purchase goods and services from that particular merchant. Often, closed loop transactions instruments may be purchased directly from the merchant. In this case, the merchant may collect payment from the card holder for value placed on the instrument, activate the card for use, and may load data to the machine readable section of the card. The merchant may then hold the pre-paid funds in a bank account that the merchant controls. The merchant may also maintain the card holder's purchase history and account balance information in its own internal systems. A vendor or retailer may sell a closed loop transaction instrument for a particular merchant if a business relationship exists, and typically may receive a commission for providing this service. The pre-paid funds collected by the vendor or retailer may then be sent directly to the merchant to hold in an account it controls. Here, again, the merchant may maintain the purchase history and cardholder balance information on its internal system or utilize an external processing company to perform these functions. Thus, in a closed loop network, a card association, issuer, and acquirer are not typically needed.

Variations of the open and closed loop transaction processes and business relationships other than those described above may exist. However, the present invention may function like a typical open or closed loop gift card that merchants, issuers, card associations, and acquirers are very familiar with. It is contemplated that the present invention customizable gift card will be able to utilize current and future methods and systems permitting these to be accepted as a form of approved payment for goods and services.

The gift card itself may include an indication of a business relationship with a merchant or set of merchants. In certain embodiments of the present invention, such as that of FIG. 1A, the indication may be in the form of a logo 60 representing a closed or open loop type of gift card. The logo, trademark, or other indication of a prearranged business relationship, provides notice to an employee, such as a store clerk, of the preexisting relationship and that a valid, authorized transaction may occur that is contingent on the electronic authorization and availability of funds associated with the gift card.

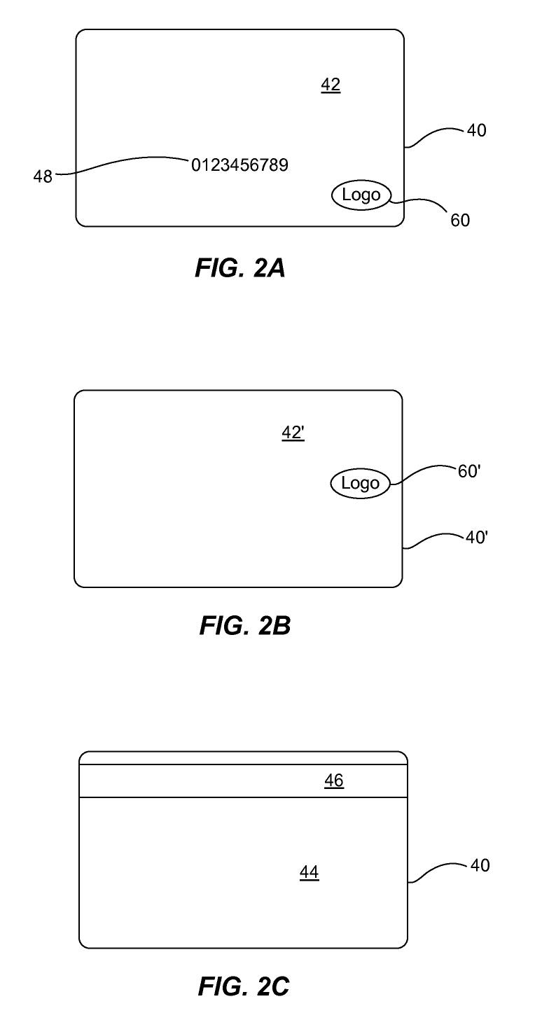

In certain embodiments of the present invention, illustrated in FIGS. 2A and 2B, the indicia carrier 40, 40′ may be available to the user with a preprinted logo, advertisement, layout, etc. (see logo 60, 60′). In another embodiment, the logo (or advertisement, layout, etc.) may be caused to be printed directly on the label. Customizing software may have a library of logos, trademarks, and other indications of a prearranged relationship agreement when such relationships exists. As will be described further below, a user may choose a set of merchants (including the set of a single merchant) for which the user intends the gift card to be used. The customizing software may be used to incorporate a logo or logos (such as logo 60) into a graphical display. A printer may then be used to transfer or print the graphical display, including the logo 60, to the label 20 to create the graphical arrangement on the indicia carrier 40. After the graphical display has been printed on the label 20, the label 20 may be joined to the indicia carrier 40. If the prearranged business relationship requires logo 60 to be in a specific location on the gift card 10, the graphical display forming the graphical arrangement may be manipulated to accommodate such a requirement. Alternatively, certain merchants may provide their own preformatted indicia carriers, which users may further personalize or customize using the features of the present invention discussed herein, namely the customization of labels that are to be attached to the preformatted indicia carriers.

In certain cases, the prearranged business relationship may be with a financial institution such as a bank. The financial institution may determine the set of merchants which may accept the gift card for facilitating payment. For example, certain bank-issued credit and debit cards may be accepted by a set of merchants participating in a credit network such as those offered by Visa® and MasterCard®. In addition to credit and debit cards, a financial institution may offer, for example gift cards formed after the manner of the present invention, which may be accepted by merchants participating in the credit network. Certain embodiments of the present invention may include provisions for personalizing and dispensing various bank-issued cards.

To accommodate the requirements of a financial institution, the gift card 10 may include other features or elements. For example, the logo 60 may be the trademark logo of the credit network, e.g., Visa® and MasterCard®. Moreover, indicia carrier 40 may include an account number associated therewith for facilitating a financial transaction executed with the gift card. Embodiments of the present invention may include arrangements where the supplier of an indicia carrier may distribute the indicia carrier having an account number encoded in a machine readable medium, discussed further below.

FIG. 2A is an illustration of a front side 42 of an exemplary indicia carrier 40. In this embodiment, identification number 48 may be located on the front side 42 of the indicia carrier 40. Identification number 48 may be in a human readable medium or configuration, such as a sequence of alphanumeric characters printed or stamped on the surface of the front side 42 of the indicia carrier 40. Identification number 48 may be supplied for use in a post point of sale activation procedure, that includes the steps, in the case of a gift card, to activate a user account, fund the gift card, receive a valid account number, and customize the visual or graphic arrangement of the gift card.

A post point of sale activation procedure may comprise the user providing the identification number 48 to a website or over a phone line. The identification number 48 may be associated with the account number 28 encoded on the machine readable medium 46. Once payment has been verified to fund the account (e.g., fund a gift card), the user may receive the account number of the card, which account number may be used in a subsequent financial transaction, such as the purchase of goods and/or services. After execution of the post point of sale activation procedure, the account number may then be visibly displayed and printed on the label 20. Thus, the label 20 may be applied to the indicia carrier following the post point of sale activation procedure. The post point of sale activation procedure is discussed in more detail below.

In one aspect, the front side of a indicia carrier can include account indicia, such as an account number or card number. Such account indicia can be exposed once a label is applied to the indicia carrier or it can be concealed by the label. In a particular aspect, the front side of the indicia carrier can include account or other indicia that is not formed from the indicia carrier (e.g., indicia that is neither embossed or debossed). In other words, the indicia are not applied to the indicia carrier in a manner that permanently deforms a portion of the indicia carrier to raise or lower that portion relative to the general surface of indicia carrier. Such embossing or debossing can adversely affect adhesion of a label applied to the indicia carrier.

FIG. 2B illustrates another example of a front side 42′ of an exemplary indicia carrier 40′. In this example, the front side 42′ is devoid of any account indicia. The indicia carrier 40′ does include a logo 60′ that can be visible or concealed once a label is applied to the front side 42′ of the indicia carrier 40′. In one aspect, it may be desirable to cover an old or outdated design or logo on a gift card or indicia carrier. In this case, a label with a new design or logo can be applied to the gift card or indicia carrier. This can give new life to old or outdated inventory.

FIG. 2C is an illustration of a back side 44 of the indicia carrier 40. As is shown in the figure, indicia carrier 40 may include a data storage area comprising a machine readable medium 46 inseparably coupled to the indicia carrier 40. The machine readable medium 46, which may be in the form of a magnetic strip 46, a bar code, an integrated circuit, or any other suitable machine readable medium, provides means by which the gift card may maintain an account number that may facilitate a financial transaction. For example, an account number may be used to provide an indication of funds available for participation in a particular transaction. An account number may be encoded on the machine readable medium 46. As should be apparent, information encoded on the machine readable medium may not be in a format that is readable by a human. As is known in the art, the funds available for a transaction, at any given time, may be actually tracked at a remote facility, such as a bank or card processor. In such cases the machine readable medium 46 may store the necessary information for accessing and tracking the funds available to the bearer of the card. In other embodiments, the funds available, at any given time, may be tracked and stored on the machine readable medium 46 similar to a stored-value card or instrument.

A back side 44 of indicia carrier 40 may include other informative elements (not shown), such as terms and conditions of use and restrictions imposed by the vender. Additionally, the back side 44 of indicia carrier 40, like the front side 42 shown in FIG. 2A, may include other graphical elements (not shown) such as a logo or a label having a graphical display similar to the labels and graphical arrangements discussed herein. The graphical elements on the back side 44 of indicia carrier 40 may include items required by terms of the prearranged business relationship as well as user-provided elements, when such are not precluded by any prearranged business relationship. In one embodiment, an identification number may be located on a back side 44 of indicia carrier 40.

As will be recognized by one skilled in the art, gift cards may include additional features directed to security or to verify the identity of the bearer, such as a pin number, signature, etc.

With reference to FIGS. 1A and 3A, the present invention further comprises a self-adhered label 20 designed to be customized, such as by a user during or in conjunction with a post point of sale activation procedure, and subsequently adhered or otherwise affixed to a indicia carrier. The label 20 is most likely initially blank without any visual indicia, however this is not intended to be limiting in any way. The embodiment illustrated in FIG. 3A depicts an embodiment of a label 20 for a gift card, as shown in FIG. 1A with an optional notch 18, although it should be recognized that the label may not include the notch. This figure depicts the label 20, discussed above and shown in FIG. 1A as part of the finished gift card, prior to being joined or otherwise affixed to the indicia carrier 40 shown in FIGS. 2A and 2C. As shown, the label 20 comprises a graphical arrangement 22 in which a layout of various designs, pictures, text, etc. may be visually presented. The label 20 may further comprise an optional cut-out or notch 18 designed to provide an unobstructed view of a logo 60 already present on the indicia carrier 40 as shown in FIG. 1A. As such, it is contemplated that the label 20 may comprise any size, shape or configuration. In addition, the label may be opaque or transparent, or may comprise in combination portions that are transparent and portions that are opaque.

In another aspect, illustrated in FIGS. 1B and 3B, the label 20′ can be sized to cover only a portion of the front side 42′ of the indicia carrier 40′ without a cut-out or notch, as discussed above. In this example, the label 20′ can be substantially rectangular in shape and sized to cover a percentage of the indicia carrier. For example, in one aspect the label can cover from between about 60% to about 90% of the indicia carrier. In a more particular aspect, the label can cover from between about 70% to about 80% of the indicia carrier. Of course, it should be recognized that the label can cover the entire front side of an indicia carrier. In this case, as in other examples, the label can include design, logo, or account indicia, alone or in any combination.

The label 20 is designed to be applied to the indicia carrier 40 using various means, such as adhesives. Types of adhesives may be used that reduce the chance of the label being tampered with or removed. The specific types of adhesives available for use are not discussed in detail herein.

The label 20 may further comprise other features and elements. For example, the label 20 may comprise fold-down edges 38 and/or cutout corners 39 that function to both facilitate the joining of the label to the indicia carrier, as well as to more securely fix the label in place. In this embodiment, the label may be properly aligned with and applied to a front side or back side of the indicia carrier, and the edges of the label subsequently folded down over or wrapped around the edges of the indicia carrier to locate the perimeter or terminating edges of the label on a surface of the indicia carrier other than the surface to which the majority of the label is affixed. For example, in the scenario in which the label is intended to be affixed to the front side of the indicia carrier, the label may be configured so that one or more of its edges terminate about an edge surface of the indicia carrier, or about an opposing surface of the indicia carrier, or rather the back side of the indicia carrier.

In another exemplary embodiment, the indicia carrier may comprise one or more raised sections or ribs, with the label sized and configured to fit within these.

In essence, the present invention contemplates any type of label that initially exists separate from the indicia carrier, that is customizable by a user after purchasing the label and indicia carrier, and that is intended to be subsequently applied to the indicia carrier to generate a usable, personalized gift card.

Having the indicia carrier separate from the customizable label may provide greater convenience to the purchaser because account funding may occur at a time and place that are remote from the indicia carrier purchase (i.e., at a time and location of the purchaser's choosing). The ability to quickly customize a card may also avoid a three to ten day processing and mailing delay that is typical in the current industry for receiving a personalized card.

Additionally, keeping the indicia carrier separate from the label displaying the account number and delaying the joining of the label and the indicia carrier until the gift card has funded, may add an additional safety feature and level of fraud protection not found in other gift cards. Printing the account number onto the label at or near the time of funding may provide fewer opportunities for an unauthorized person to gain access to the account number to potentially use the funds for phone or on-line purchases before a bona fide card holder uses the funds in the account. This is an on-going problem in the pre-paid/gift card industry and the reason special packaging is required for most gift cards displayed at retail locations (especially with open loop cards). Often, retail gift card packaging also advises customers not to purchase cards if the package has been tampered with in the event the account number has been viewed. Additionally, some open loop card companies will not send gift card orders over $200 by standard U.S. Postal Service (FedEx® or UPS® may be required at an additional cost) to help avoid activated cards from being stolen or intercepted. The ability to postpone displaying the account number until the indicia carrier has been purchased, the account has been funded, and the label has been printed may help avoid the issues caused by the mailing of activated instruments and may be considered additional safety features provided by the present invention. Although the embodiments discussed above are contemplated herein, these are not meant to be limiting as other embodiments are possible as also discussed herein.

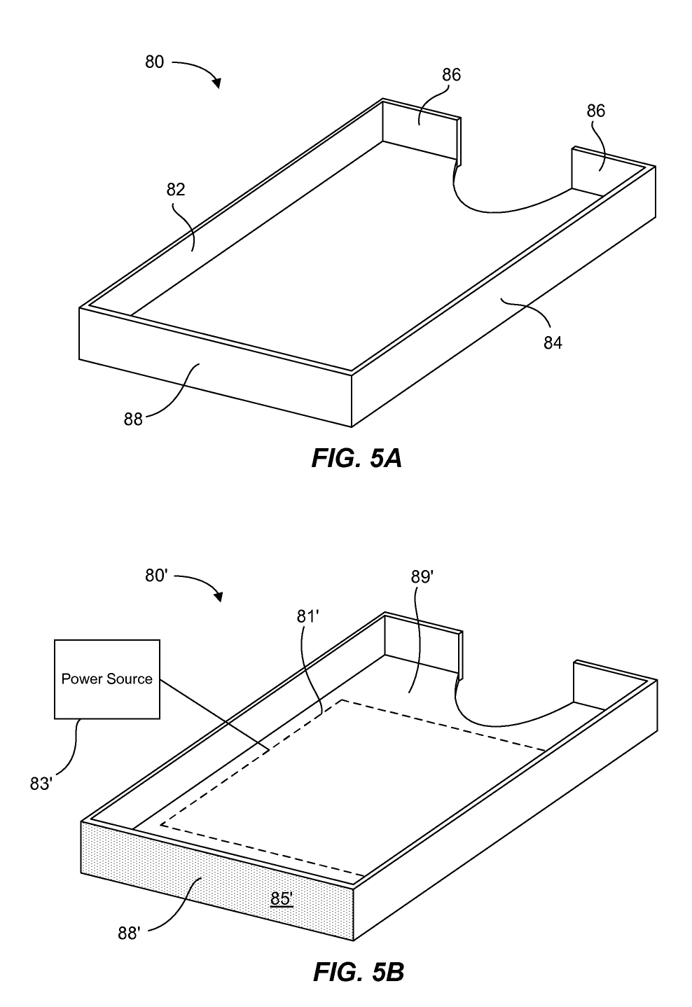

FIG. 4 illustrates the label 20 of FIG. 3A, having an adhesive backing, being joined to the indicia carrier 40 shown in FIG. 2A to create a finished usable gift card, such as the one illustrated in FIG. 1A. In this embodiment, the label 20 may conceal the identification number 48 initially associated with the indicia carrier in the event such is located on the indicia carrier. However, this may not be the case in other embodiments as an identification number may be allied with an indicia carrier in other ways, such as via a removable sticker or package insert.

Note that in this embodiment the label 20 is being applied to the front side of the indicia carrier. A first end of the label 20 is shown as being aligned and applied to a first end of the indicia carrier, with the second end of the label being applied to a second end of the indicia carrier. The notch or cutout 18 is positioned so that it does not obscure the logo 60. In other embodiments, the logo 60 may be printed on the label 20 itself, or it may be located on the back side 44 of the indicia carrier 40.

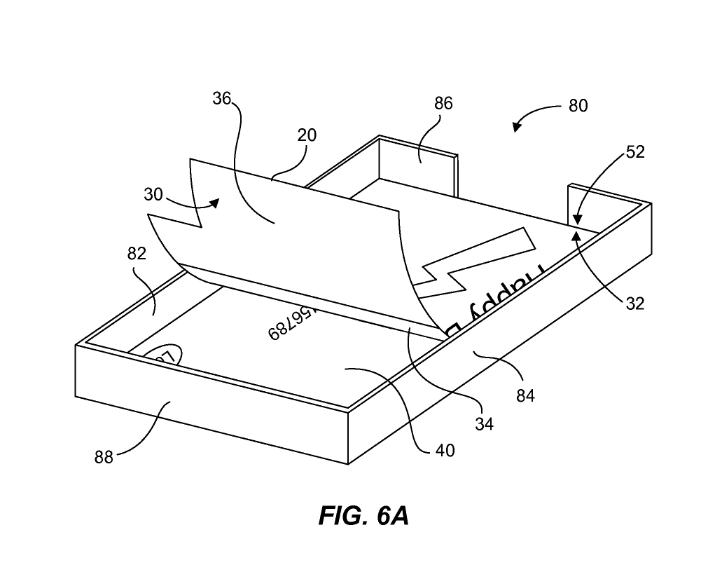

The present invention further comprises a label applicator designed to facilitate easy and efficient application of the label to the indicia carrier once the label has been suitably customized, and particularly more precise alignment of the label with the indicia carrier. FIG. 5A illustrates a label applicator 80 formed in accordance with one exemplary embodiment of the present invention. As stated, the label applicator 80 may be used to facilitate alignment of the label with the indicia carrier when joining the label to the indicia carrier. The applicator may be sized and configured to receive an indicia carrier between side walls 82, 84, 86, 88, with the size of the indicia carrier and the size of the applicator fitting within close tolerances so that little or negligible movement of the indicia carrier is permitted once properly inserted and seated within the label applicator. While functioning to constrain the indicia carrier, the side walls 82, 84, 86, 88 may also function to guide a label into correct alignment as it is being joined to an indicia carrier. In one aspect, the label applicator can be used to align at least one edge of a label with at least one edge of an indicia carrier. In a particular aspect, the label applicator can be used to align at least two edges of a label with at least two corresponding edges of an indicia carrier. For example, the label applicator can be used to align three or four edges of a label with three or four edges of an indicia carrier. This precise alignment will greatly assist in making sure that no part of the label overhangs the indicia carrier, thus reducing the likelihood that the label will peel from the surface of the indicia carrier and that no adhesive will collect on the surface or edges of the indicia carrier, and thus allowing the finished gift card to operate as intended and to work properly in various card reading machines having tight tolerances, particularly those in which the card is inserted into a machine, such as at a gas station pump.

FIG. 5B illustrates a label applicator 80′ formed in accordance with another exemplary embodiment of the present invention. This example illustrates the label applicator having a heat source 81′. The heat source can be disposed on, in, or under a base 89′ of the label applicator 80′. The heat source can comprise a plate, coil, or other heat conducting structure. The heat source 81′ can be connected to a power source 83′ to provide power for the heat source. The power source can be located proximate to or remote from the heat source. In one aspect, the power source can be a battery supported within the label applicator. In another aspect, the power source can be remotely located relative to the label applicator (e.g., an electrical wall outlet) and can be connected to the label applicator via a power cord. In one aspect, the side walls can include a taper to allow extra space at the top for receiving a label and an indicia carrier. The tapered portion of the walls can terminate at or near the base, with any remaining portion of the walls being substantially perpendicular with respect to the base.

Additionally, FIG. 5B illustrates the label applicator 80′ having an abrader 85′. The abrader can be used to abrade at least a portion of a surface of an indicia carrier prior to applying the label to the indicia carrier to improve adhesion of the label to the indicia carrier. For example, the abrader can be used to “rough up” a smooth surface of the indicia carrier, which may provide a better surface finish for adhering a label to the indicia carrier. The abrader can include any abrasive such as sandpaper, grit, rasps, files, protrusions, or any other abrasive substance or device. The abrader can be formed separately and attached to the label applicator or it can be integrally formed in the applicator. The abrader is shown as being located on side wall 88′ of the label applicator, but it should be recognized that the abrader can be located anywhere on the label applicator, such as a bottom surface of the base 89′ or on any one or more of the side walls.

A label applicator can be used to improve the aesthetics and/or functionality of a gift card. For example, by providing a sufficient alignment between the edges of the label and the indicia carrier, the edges of the label are prevented from peeling away from the indicia carrier. This can preserve the appearance of the gift card. This can also aid in the functionality of the gift card, since it is more likely to fit and slide through a card scanner and is less likely to jam or cause errors in reading card data. An improperly applied label is one that extends past an edge of the indicia carrier, which can effectively increase the size or dimension of the gift card, and can greatly interfere with its performance. Some card readers are extremely sensitive to card dimensions and have extremely tight tolerances, allowing only about 0.002 in clearance on a length or width dimension. Thus, an improperly aligned label can result in a non-functioning gift card for these card readers. Furthermore, a portion of a label extending beyond an edge of an indicia carrier can expose adhesive that may come into contact with a card reader. Exposed adhesive can then accumulate on the indicia carrier and/or the card reader, which can increase friction or effectively reduce the available space for the card to slide through the card reader. Exposed adhesive can also attract dirt and debris that can further hinder operation of the operation of the gift card. This can increase incidents of jamming and can render a gift card useless for that card reader, or worse, can lead to damage of the card reader or necessitate a repair of the card reader.

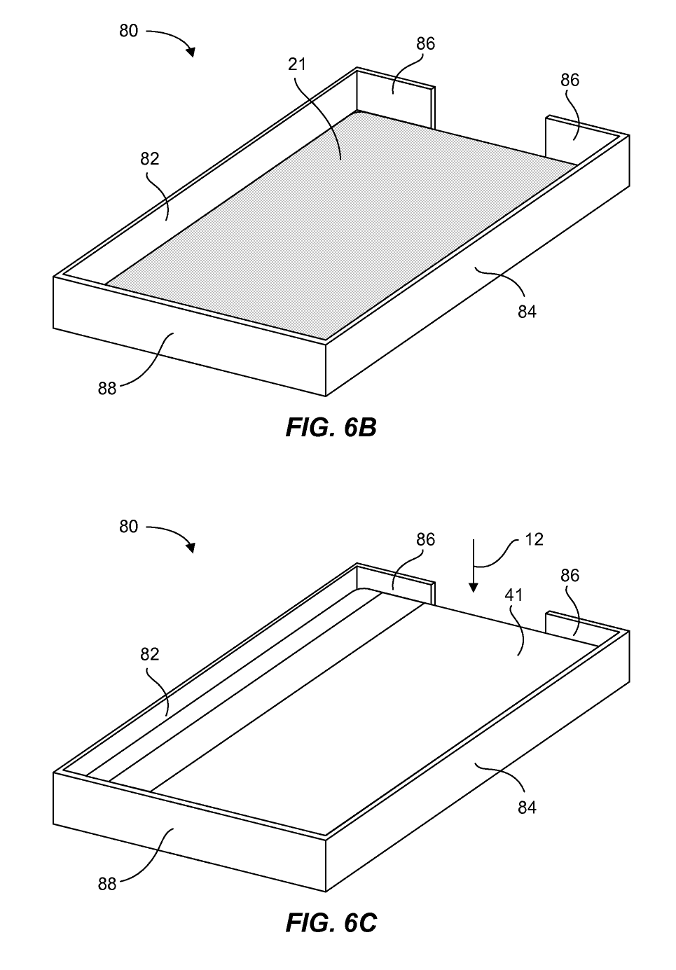

FIG. 6A illustrates the label 20 as it is being applied to the indicia carrier 40 using the label applicator 80. In one exemplary embodiment, a portion of a protective cover may be removed from an end 32 of an adhesive side 30 of the label 20. This end 32 of the label 20 may be oriented toward a corresponding end 52 of the indicia carrier 40. The side walls 82, 84, 86, 88 of the applicator 80 may guide the end 32 and edges of the label, such that the end 32 and edges of the label 20 are aligned with the end and edges of the indicia carrier 40. At this point, the exposed adhesive 34 of the label 20 may be joined to the indicia carrier 40. Following this, another portion 36 of the protective cover may be removed to expose more of the adhesive of the label 20. In this way, the label 20 may be progressively joined to the indicia carrier 40 using the label applicator 80 to facilitate correct alignment. The label is properly joined to the indicia carrier as one step in creating a usable gift card. Once the label is in place about the indicia carrier, these may be removed from the label applicator. It is noted that the label may be customized and subsequently applied to the indicia carrier either before or after the account is activated and funded. Once the account has been activated, the account funded, and the label applied to the indicia carrier, the resulting gift card will typically be ready for use.

FIGS. 6B and 6C illustrate another example of applying a label to an indicia carrier using a label applicator. In this example, a label 21 can be disposed in the label applicator 80 with a front side of the label face down and an adhesive (sticky) side being face up. The side walls 82, 84, 86, 88 of the applicator 80 may guide the label 21, such that at least an end and edges of the label are aligned with an end (i.e. at wall 88 or 86) and edges (i.e. at walls 82 and 84) of the label applicator. The side walls of the applicator may similarly guide the ends and edges of an indicia carrier 41 as it moves in direction 12 into an aligned position and into contact with the label. The indicia carrier can be pressed onto the label to maximize adhesion of the label to the indicia carrier. Following this, the indicia carrier and label can be removed from the label applicator as a gift card having a customized label. In a particular aspect, a heat source can be used to apply heat to the label and/or the indicia carrier to improve adhesion of the label to the indicia carrier.

While much of the above description has focused on the physical nature of the gift card and the elements this gift card is comprised of, the present invention further comprises other aspects.

For example, in one aspect, a system for customizing a gift card is presented. Such a system can include an indicia carrier, a label, and a label applicator, as in any of the embodiments discussed above. The system can further include means for customizing the label with a customized display and a printer to print the customized display on the label. These are discussed in more detail below.

In another aspect, a method for facilitating the creation of a customized gift card is presented. The method can comprise making available a indicia carrier having a machine readable medium for an encoded account number supported on one side of the indicia carrier. On an opposite side, the indicia carrier is devoid of account indicia, such as embossed account indicia. The indicia carrier can be made available, for example, at a point of sale by providing the indicia carrier on a rack or making it available from behind a counter upon request. In one aspect, the indicia carrier can be made available by mail upon request by ordering online, by phone, or by mail. In another aspect, the indicia carrier can be made available after a label has been applied to the indicia carrier (e.g., where a merchant creates a number of customized gift cards and offers these for sale to customers).

The method can further comprise making available a label to be applied to the indicia carrier. The label can be made available in a manner similar to any of the above examples pertaining to making an indicia carrier available. In one aspect, the label can be made available after a customized display has been printed on the label (e.g., selecting from a plurality of pre-customized labels at a point of sale to be applied to a indicia carrier) or after the label has been applied to an indicia carrier.

The method can further comprise facilitating customization of the label to comprise a customized display. Customization of a display is discussed in more detail elsewhere in the present disclosure, however, facilitating customization can include providing means for customizing, such as a computer at a kiosk as well as customization software either installed on the computer or available over a computer network such as an intranet or the internet. Furthermore, facilitating customization can include providing network access to stored data, which can be retrieved to create at least a part of a customized image. In a particular aspect, the data is stored on and retrieved from an internet accessible database. For example, the internet accessible database can include social networking websites such as FACEBOOK or MYSPACE or web-based image databases such as PHOTOBUCKET, PICASA, KODAK GALLERY, SNAPFISH, or the like.

The method can also include facilitating printing of the customized display on the label. This can include providing a printer, such as at a kiosk or elsewhere at a point of sale. The printer can be used to print a customized display on a label and can be operated by a customer or by an employee at a point of sale. Additionally, the method can comprise facilitating application of the label to the indicia carrier. This can include providing a label applicator or other manually operated device for aligning or applying a label to an indicia carrier. The label applicator can be operated or controlled by a customer or an employee at the point of sale, or by a user at a post point of sale location.

In one aspect of the method, any or all of the above activities can occur at a point of sale. In another aspect, one or more of the above activities can occur at a location other than a point of sale, such as at a post point of sale location (e.g., a home or office) where customization may be facilitated by accessing a remotely located database over the internet. In addition, one skilled in the art will recognize that any combination of the method steps described herein can take place at both a point of sale location and at a post point of sale location.

Thus, in one example, a point of sale retailer can have a supply of stock or other indicia carriers and blank or at least partially labels available for customers. The indicia carriers and labels can be available on a display rack or upon request from a secure location behind a sales counter. The retailer can also have a computer or a kiosk that can be used by a customer or an employee to customize a display for a gift card. The computer can have customization software loaded on the machine or it can have access to customization tools and data available through a network, such as the internet. Images, such as photographs can be used in the customization program and incorporated into the design of the gift card display of the label via any known method for transferring data files from one device to another. For example, files can be transferred to the computer via Bluetooth, wired connections, memory cards, picture messages over a cellular phone network, or downloaded from the internet.

Once a gift card design has been finalized, the design can be printed on the label using a printer. The printer can be located at the retailer for convenience, in this example. The retailer can also provide a manually operated device, such as a label applicator, for aligning the label with the indicia carrier when joining or applying the label to the indicia carrier, so that the gift card will function properly with card reading equipment. Either the customer or the employee can join or apply the label to the indicia carrier.

In a variation of the above example, the customer can create a customized design at home or at an office and can then have the design printed on a label made available at the retailer's or merchant's location. The design can be transferred to the retailer or merchant by any known method for transferring data files. In one aspect, the design can be emailed to the retailer or merchant. In another aspect, the design can be saved in a database associated with a web-based customization program offered by the retailer or merchant that is used to create the design. The customer or retailer can then access the design for printing at the retailer's location on a printer.

In one aspect, a method for creating a customized gift card is presented. The method can comprise obtaining a indicia carrier having a machine readable medium for an encoded account number supported on one side of the indicia carrier and being devoid of (e.g., embossed) account indicia on an opposite side. The indicia carrier can be obtained from a point of sale or ordered and received via mail or delivery. A customer or an employee at a point of sale can obtain the indicia carrier. The method can further comprise customizing a display for the indicia carrier. A customer (at home, at an office, or at a point of sale) or an employee at a point of sale, for example, can customize the display. Customizing the display for the indicia carrier can include retrieving stored data from an internet accessible database such as a social networking site or an image database. The method can also comprise printing the display on a label. This can be performed by a customer (at home, at an office, or at a point of sale) or an employee at a point of sale. A printer can be used to print the display on the label. Additionally, the method can comprise joining or applying the label to the indicia carrier. This, also, can be done by a customer (at a home, at an office, or at a point of sale) or an employee at a point of sale. In one aspect of the method, any or all of the above activities can occur at a point of sale. In another aspect, any or all of the above activities can occur at a location other than a point of sale, such as at a home or office.

Thus, in one example, a customer can acquire an indicia carrier from a supplier such as a retailer or merchant. The indicia carrier can be picked up by the customer or shipped to the customer. The customer can also create a customized design at home or at an office using customization software that is locally installed on the customer's computer or is a web-based application accessible by the customer's computer. The design can be printed on a label using the customer's computer. The customer can then join the label to the indicia carrier to complete the customized gift card. The customer can use a manually operated device, such as a label applicator to align the label to the indicia carrier when joining the label to the indicia carrier.

In a variation of the above example, the customer can transfer the customized design to the retailer for printing the label at the retailer. The printed label can then be applied to an indicia carrier at the retailer. In another variation, customer can create a customized design at the retailer using the retailer's computer or kiosk. The customer can print the design at the retailer using the retailer's printer. In yet another variation, the retailer can create a customized design, such as a promotional theme, and can print the design on a label and join the label to an indicia carrier to create a customized gift card for sale.

It should be recognized that a label can be joined to an indicia carrier by any known means. For example, a label can be applied using a machine that is automated to join labels to indicia carriers with minimal human intervention. In another aspect, a gift card can be applied using a device that is manually operated and requires significant human input to be effective. A label applicator, as described in the present disclosure is an example of such a manually operated device, although it should be recognized that the label applicator is only one example of such a manually operated device. Indeed, any manually operated device is contemplated capable of performing the function of facilitating proper and precise alignment of the label with the indicia carrier is considered to be within the scope of the present invention. In yet another aspect, the label can be applied manually, or without the use of any device, to an indicia carrier.

It should also be recognized that after printing the graphical layout on the label, the finished label may be joined to the indicia carrier. In one embodiment, the label may be joined to a front side of the indicia carrier. In another embodiment, the label may be joined to the back side of the indicia carrier. In yet another embodiment, there may be more than one label joined to the indicia carrier. In this embodiment, for example, one label may be joined to the front side of the indicia carrier and one label may be joined to the back side of the indicia carrier. In another example of this embodiment, more than one label may be joined to the front side and/or the back side of the indicia carrier.

In one aspect, from a user standpoint, a system and method for generating such a gift card, and for preparing a gift card for use are presented. In another aspect, from an administrator standpoint, a system and method for facilitating creation and use of a gift card are presented. Exemplary systems and methods are described below.

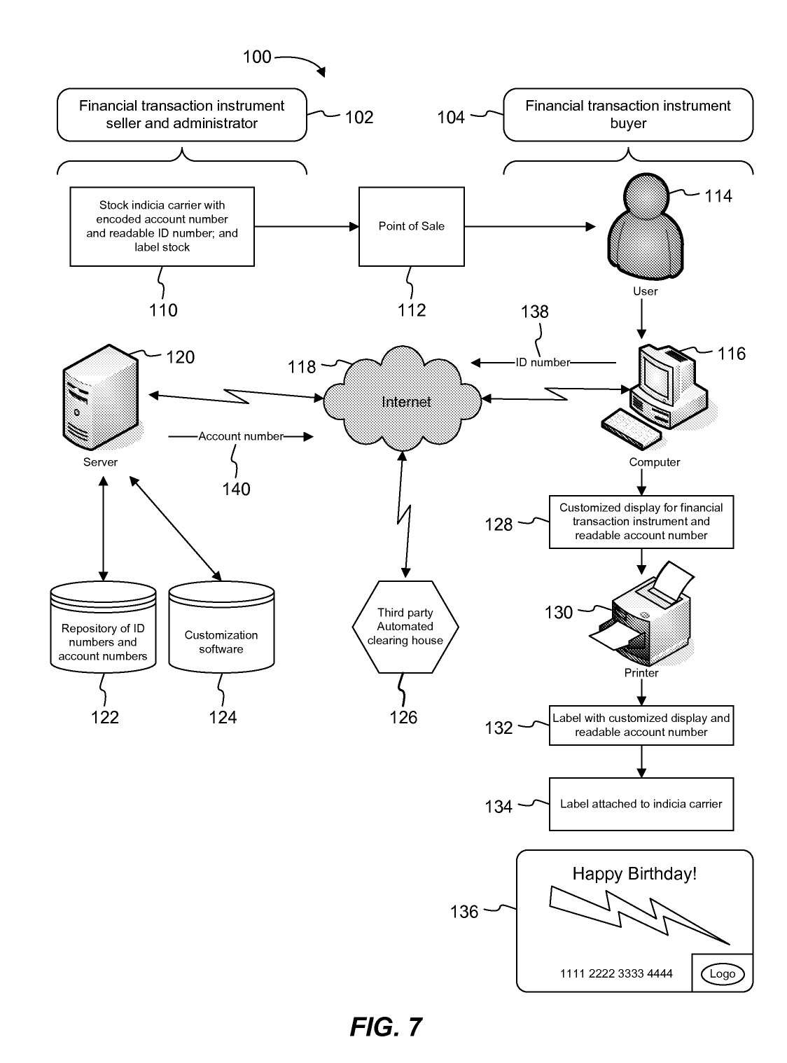

FIG. 7 illustrates a system for generating a gift card in accordance with one exemplary embodiment of the present invention. The figure depicts components of the system attributed to a gift card seller (e.g., merchant) and/or administrator 102 and components attributed to a gift card buyer 104.

A gift card seller may provide a indicia carrier 110 and separate label stock purchasable by a buyer (user 114) at a point of sale 112, which indicia carrier comprises a machine readable medium supported thereon, and an identification number associated with an account number encoded on the machine readable medium. At the time of purchase, the indicia carrier would not be suitable for use in a financial transaction, much like prior related gift cards are not usable until funded and/or activated. As discussed, a gift card, and particularly the indicia carrier, may support a machine readable medium comprising information that may facilitate a financial transaction. For example, an account number may be encoded on the machine readable medium, which account number, once activated by the user using the identification number, may be used to initiate and complete an electronically authorized or approved financial transaction. In most cases, the account number encoded on the machine readable medium will not be readable by, visible to, or otherwise known to a human until an account and the account number is activated by the user in accordance with an activation process discussed in detail below.

Initially concealing the account number and making it available only after completion of an activation process by the user may provide a security feature for the gift card. For example, an encoded account number may not be readily ascertainable by a person attempting to defraud a future buyer of a gift card. Thus, a fraudulent person may be prevented from easily acquiring an account number of a gift card because the account number is not present on the indicia carrier in a human readable format. A fraudulent person may need to acquire a machine, such as a card reader, to ascertain the account number on a card. The user, on the other hand, may acquire the account number in a human readable format by providing the identification number supplied with the indicia carrier that is associated with the account number and funding an account associated with the gift card. This exchange of an identification number and funds for an account number may be part of a post point of sale activation system and is explained in more detail below.

The identification number may be presented in a human readable format or medium and may comprise any combination of alphanumeric characters, for example. The identification number may be located on a indicia carrier, such as by printing the identification number directly on the indicia carrier or on a temporary sticker bearing the identification number to the indicia carrier. In another embodiment, an identification number may be provided separately from, or in other words not attached to, the indicia carrier. For example, the identification number may be provided on a paper insert supplied with or included in the packaging of the indicia carrier. An identification number may also incorporate security features to prevent fraud. For example, an identification number may be covered by a “scratch off” material to alert a potential buyer that the identification number may have been acquired by a fraudulent person and the associated account compromised.

In certain embodiments, a user may not activate the account and obtain a usable gift card at the point of sale, as with some prior related gift cards. In these embodiments, the user may activate the account and obtain a usable gift card at a time and location of convenience, such as at a later date at home or at work. In this regard, the system may provide a convenient method by which a user can prepare and use gift cards distinct from prior related gift cards.

In one example, a user may purchase or acquire one or more indicia carriers and labels at a point of sale, such as at a grocery store, drug store, bank, or other location. The user may wish to give various gift cards as birthday presents to family members throughout the year. In accordance with the present invention, an account associated with the various indicia carriers may be selectively activated, and a label may be customized with a graphical arrangement or display and joined to the indicia carrier to make a memorable gift card tailored to the specific individual receiving the gift card.

In one embodiment, the seller may provide an adhesive label adapted for application onto at least a part of a surface of the indicia carrier. In another embodiment, the user may provide a label to join with the indicia carrier. Suitable labels may be self-adhesive or they may be configured to be joined to the indicia carrier in any way known in the art.

Accordingly, a system for generating a gift card may include means for customizing the label. Such means may comprise customizing software, as discussed above. Means for customizing the label can also include a computer to execute the customizing software. The computer can be a general use computer, such as a PC or laptop, or it can be a dedicated use computer configured with specific hardware for executing the customization software. One example of a dedicated use computer can be incorporated into a kiosk at a point of sale for the indicia carrier and/or the labels. For example, a kiosk at a point of sale may be used by a customer and/or an employee to design a customized display for a label. The kiosk can optionally include a printer to print the customized display on the label. Alternatively, the kiosk can be linked to a printer located elsewhere, such as at another location within a point of sale store.

In one embodiment, the seller may provide customizing software, such as on a CD-ROM or other machine readable media, in the same package with the indicia carrier. In another embodiment, the seller may make customizing software 124 available to the user over the internet 118. For example, the user may access a website and download a copy of the customizing software or the customizing software may be made available through an online, web-based format, the software being run at a location remote from the user. As discussed above, a kiosk may be networked to the internet such that a customized display can be created using the kiosk.

In certain embodiments, the customizing software may be incorporated into a post point of sale activation system, in which the user is given the opportunity to customize the label in conjunction with the account activation sequence. In other embodiments, the customizing software may be independent of the post point of sale activation system. In these embodiments, the label may be customized independent from an exchange of identification numbers, funds, and account numbers.

Once the user has acquired the indicia carrier having an encoded account number and a corresponding identification number, the user may activate the account and obtain a usable gift card by accessing and utilizing a post point of sale activation system provided by the seller or administrator. Thus, the user may remotely access the post point of sale activation system to activate a gift card at a date and time of convenience.

A post point of sale activation system may comprise a repository 122 of account numbers and corresponding identification numbers. Such a repository may comprise a database connected to a server 120. In one embodiment, the server may be associated with a website accessible by the user. In another embodiment, the server may be associated with a telephone system. In either embodiment, the system may facilitate a transfer of data between the user and the repository of account numbers and identification numbers during a post point of sale activation process for the purpose of activating a user account, which activation will likely include funding of the account. Among the account numbers and identification numbers in the repository, each of the account numbers may be associated with a corresponding identification number supplied with a respective indicia carrier. This account number may be the same as the account number that is encoded on the machine readable medium supported on the indicia carrier. Each indicia carrier may have associated therewith its own identification number and corresponding account number.

The user may receive the account number in a human readable format by providing the identification number 138 supplied with the indicia carrier 110 to the post point of sale activation system. The account number 140 provided to the user is retrieved from the repository 122 using the corresponding identification number 138 that was supplied by the user. In one embodiment, the account number may be displayed on a computer screen. In another embodiment, the account number may be communicated audibly over a telephone line. In yet another embodiment, the account number may not be known by the user until the label is printed and the account number is caused to be displayed thereon.

In certain embodiments, a post point of sale activation system may include a repository of images (not shown) stored on the server 120 that may be accessed by the customization software when creating a graphical layout for a gift card. Such a repository may be the sole source of images or it may supplement those provided by the user or otherwise used or accessed by the customization software. In some embodiments, the repository of images may include logos from merchants, sponsors, credit institutions, or other corporate entities that may be involved in a financial transaction associated with the gift card.

A post point of sale activation system provided by the seller or administrator may also comprise means for funding an account. Until an account has been funded, it may be said to be an inactive account. When the user provides an identification number 138, the user may also fund the account associated with the gift card. For example, the user may provide financial information such as a credit card number, debit card number, bank account number, or other account number in order to fund the account. Means for funding the account may comprise a third party such as an automated clearing house 126 for facilitating a transaction to fund the account. Such means for funding are known in the art and may be incorporated into the present post point of sale activation system in one or more ways apparent to those skilled in the art. Communication with the parties or entities involved in the means for funding may be done over the internet 118 or over a phone line, for example.

During post point of sale activation, the user may choose which type of gift card to create. In other words, the seller or administrator may provide the user with options pertaining to the type of financial network on which the gift card may be used. For example, in certain embodiments, the user may choose to create a gift card that is recognized on an open financial network (i.e. universally accepted wherever credit cards are normally accepted). In certain other embodiments, the user may choose to create a gift card that is recognized on a closed financial network (i.e. accepted only within a certain network of a specified merchant or group of merchants). The seller or administrator may enter into prearranged business relationships with merchants or banks, as discussed above, to determine the terms and availability of open and closed networks that the user may select.

In certain embodiments, until the user makes an election, the account number encoded on the indicia carrier may not have been assigned to a particular network. In other embodiments, the account number may be pre-assigned to a particular network before the user acquires the indicia carrier. In one embodiment, even where the account number has been pre-assigned to a closed network, the user may elect which merchant or merchants may be in the closed network. For example, a user creating a closed network gift card for a teenage boy may select a video game store, an electronics store, and a clothing store as merchants on the closed network. The user may select these stores from a list of available merchants that have entered into a prearranged business relationship, as discussed above, to be a part of a customizable and selectable closed network. Thus, the teenage boy may use the gift card at any or all of the three stores that recognize his gift card, excluding any other store not selected as part of the closed network. On the other hand, an open network gift card may be accepted at a wide range of merchants due to a prearranged business relationship with a bank, a credit card company, or other financial entity, as discussed above, to enable participation in an open system. This option to select an open or closed network and specific merchants or types of merchants may contribute to the customizable nature of the gift card.

Certain embodiments may allow the gift card to be refreshed, i.e., the funds available to the gift card may be renewed to the previous value or, if desired, a different value. For example, a user or recipient of a gift card may access an account refreshing system via a website or a telephone, which system may be operated and provided by the same administrator of the post point of sale activation system. The user may provide the account number of the gift card and add funds to the account in a manner similar to method used for initially funding the account. In some embodiments, the user may opt to redesign certain characteristics of the gift card. For example, the user may have the option of selecting whether the gift card is recognized on an open or a closed network, or whether a new label should be created bearing a different graphical arrangement. If a closed network is desired, the user may select one or more merchants to be part of the closed network. Thus, the user may be provided with another opportunity to customize the gift card by changing from an open network to a closed network and vice versa.

In certain embodiments, once the user has activated the gift card and customized a graphical layout for the appearance of the label, the label may be printed. A graphical arrangement 128 may include the account number received from the post point of sale activation system. Thus, receiving the account number and using the customizing software may facilitate printing the account number on the label using a printer 130. In one embodiment, a suitable printer may be any home or office printer capable of printing on self-adhesive label stock.

Certain embodiments may allow the design of a new graphical arrangement after a gift card has already been in activated and in use. For example, when a gift card has been refreshed, the user may wish to create a new label for the gift card. The new label may have the same graphical arrangement as the original label or it may comprise a new graphical arrangement or design. As with the design and creation of the original graphical arrangement, customization software may be used to create a new graphical arrangement for a new label. The label may then be placed over the old label or the old label peeled off prior to applying the new one.

After printing the graphical layout on the label, the finished label 132 may be joined 134 to the indicia carrier. In certain embodiments where the account number is visibly displayed in a human readable format on the label, joining the label to the indicia carrier may “complete” the formation of the gift card. In other words, the gift card may be considered prepared for use 136.

Additionally, the label may have a coating or other type of protective layer applied after printing to protect the printed graphical layout. Such a protective layer may comprise any suitable protective material known in the art such as a clear or colored liquid, plastic sheet, etc. A protective layer may also be applied to an indicia carrier before or after the label has been joined to the indicia carrier.

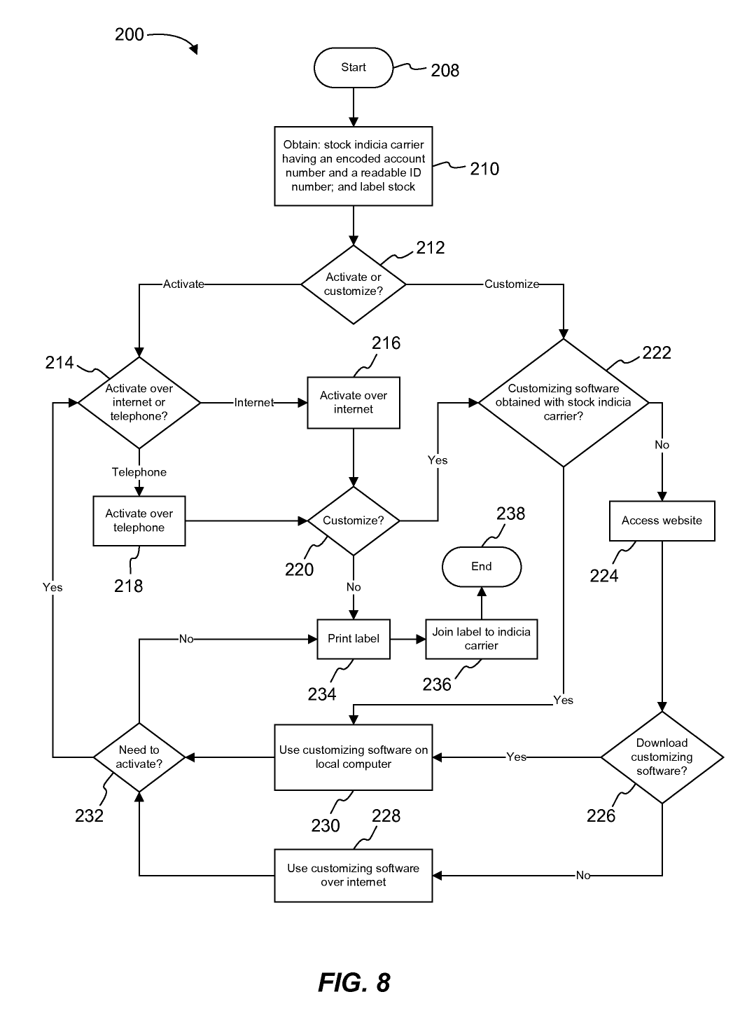

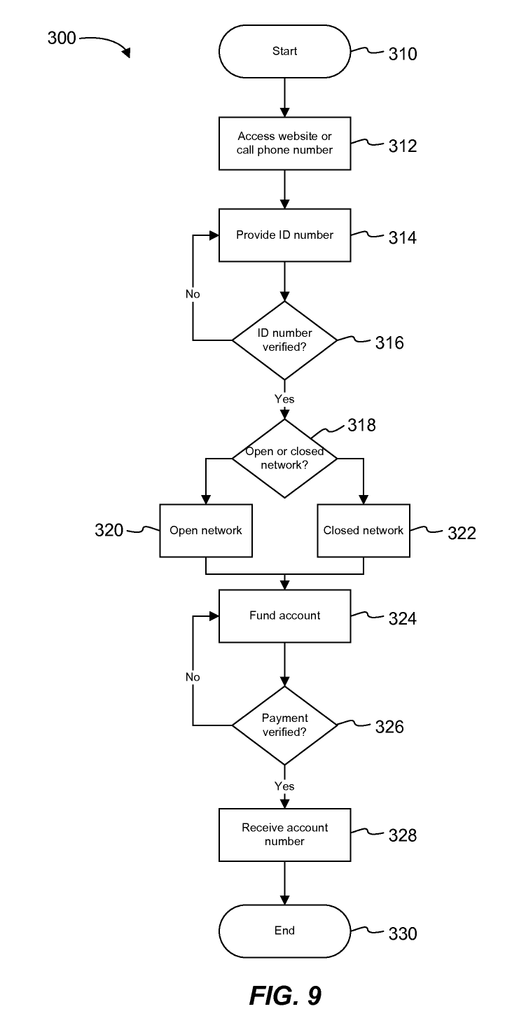

FIG. 8 illustrates a block diagram of an exemplary embodiment of a process for preparing a gift card for use. Upon initiating the process in block 208, the first step in block 210 may be obtaining a indicia carrier having an account number encoded in a machine readable medium, an identification number in a human readable medium, and label stock. As shown in block 212, a user may then have the option of activating the gift card or customizing the gift card. If the user opts to activate the transaction instrument, the user may have a further option in block 214 of whether to activate over the internet or over a telephone. Blocks 216 and 218 illustrate activating over the internet and over a telephone, respectively. The process of activating over both the internet and a telephone is depicted in FIG. 9 and is further discussed below.

Once the gift card has been activated, the user has the option, in block 220, of whether to customize a graphical layout for the gift card. Whether or not the gift card has been activated previously, the next step following the decision to customize is the same. Indicated at block 222, the user may determine whether customizing software was obtained with the indicia carrier. If not, block 224 indicates that the user may access a website and decide whether to download customizing software at block 226. If the user decides not to download the customizing software from the website, then the user may opt to use the customizing software over the internet at block 228. If the user decides to download the customizing software from the website or the customizing software was obtained with the indicia carrier, the user may use the customizing software on a local computer such as a laptop, home, or office computer.

After customizing the graphical layout or display intended for use on the gift card, the user may determine whether there is a need to activate the gift card as indicated at block 232. If there is no need to activate the gift card, then the user may print the label having the customized graphical layout at block 234. If the user has not previously activated the gift card, then the user may proceed to activate the gift card beginning with block 214, as discussed above. Once the label has been printed, the user may then join the label to the indicia carrier at block 236. At this point, block 238 indicates that the gift card has been prepared and is ready for use. The user may then proceed to use the gift card, or convey it to another individual (e.g., present a formed gift card to a recipient as a gift).

FIG. 9 illustrates a block diagram of an exemplary embodiment of a user initiated process for activating a gift card using a post point of sale activation system. Upon initiating the process at 310, the user may access a website or call a phone number at block 312. This may grant the user access to a repository of account numbers and corresponding identification numbers.

Once the user has accessed the website or called the phone number, the user may provide the identification number supplied with the indicia carrier at block 314. The identification number supplied with the indicia carrier may be used during the post point of sale activation procedure because one of the account numbers in the repository is associated with the identification number, as discussed above.

If the identification number is not verified at block 316, then the user may need to provide the identification number again at block 314. If the identification number is verified at block 316, then the user may select whether the gift card will be recognized on an open network or a closed network at block 318. An open network is at block 320 and a closed network is at block 322. Open and closed networks are discussed in more detail above.

Following this, at block 324, the user may then fund the account that is identified by the account number associated with the identification number. If payment is not verified at block 326, then the user may need to try again to fund the account at block 316. If payment is verified at block 326, then the user may receive the account number from the repository at block 328.

At this point, block 330 indicates that the gift card activation procedure has been completed. It should be recognized that the block diagram in FIG. 9 represents an embodiment of activating a gift card. The elements of funding the account and selecting an open or closed account may occur in any order so long as the user provides an identification number and funds the account in exchange for the account number.

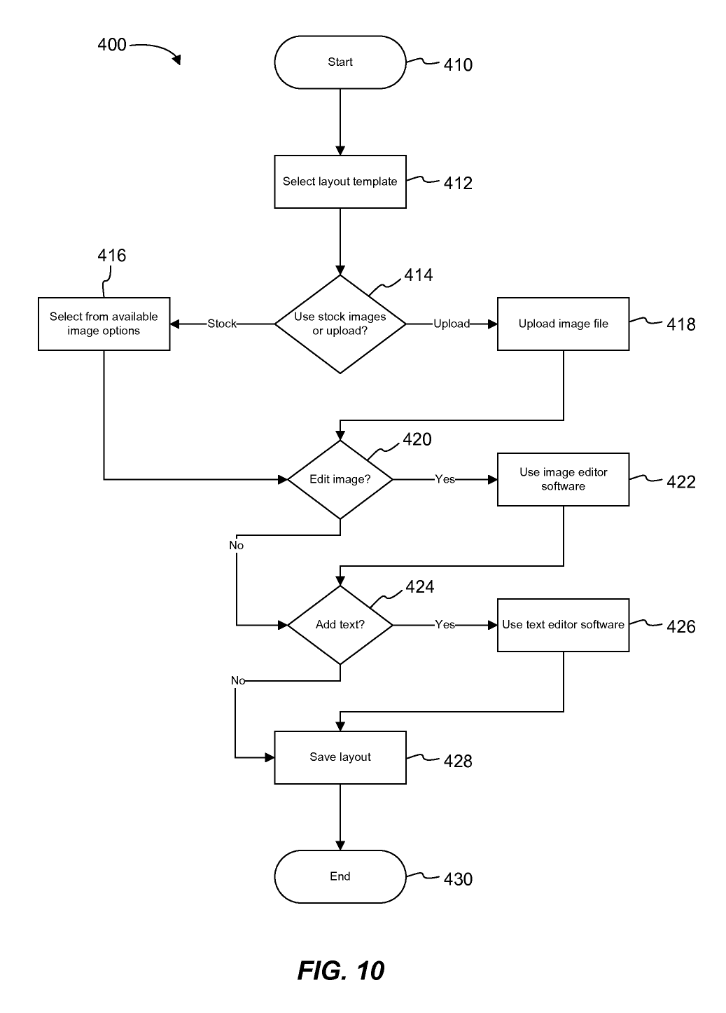

FIG. 10 illustrates a block diagram of an exemplary embodiment of customizing a layout for a gift card. Upon initiating the process at block 410 by running customization software, the user may select a layout template for the graphical design of the gift card at block 412. At block 414, the user may decide whether to use stock images provided with the customization software or to upload an image to be a part of the graphical design layout, or both. If stock images are to be used, the user may select from among the available options at block 416. If an image is to be uploaded, the user may do that at block 418.

Once an image has been chosen, the user may decide whether to edit the image at block 420. If the use decides to edit the image, the user may utilize image editing software at block 422. Next, the user may decide whether to add text to the graphical design at block 424. If the user decides to add text, the user may utilize a text editor at block 426. Next, the user may save the layout at block 428 and exit the customization software at block 430. It should be recognized that the block diagram in FIG. 10 represents an exemplary embodiment of customizing a layout for a gift card. The elements shown may be added to, rearranged or otherwise manipulated to achieve a desired result from the customization software.

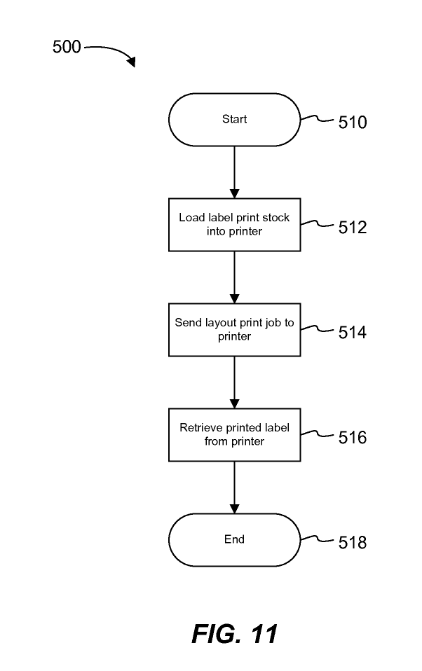

FIG. 11 illustrates a block diagram of an exemplary embodiment of printing a label for application to a indicia carrier to generate or form a ready-for-use gift card. Upon initiating the process at block 510, the user may load label print stock into a printer at block 512. Label print stock may be provided with the indicia carrier or provided separately. The user may then send a graphical layout print job to the printer at block 514. The customized graphical layout may include the account number. Thus, the printed label may include the account number visible on an exposed (printed) side of the label. Once the printer has executed the print job and printed the graphical design on the label, the user may retrieve the printed label from the printer at block 516, thus completing the process of printing a label for a gift card at block 518. It should be recognized that the block diagram in FIG. 11 represents an exemplary embodiment of printing a label for a gift card. The elements shown may be added to, rearranged or otherwise manipulated to achieve a desired result of printing the graphical design layout on a label.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

What is claimed and desired to be secured by Letters Patent is:

1. A system for customizing a gift card, comprising:
a indicia carrier having a machine readable medium for an encoded account number supported on one side of the indicia carrier;
a self-adhesive label adapted for application onto at least part of a surface of said indicia carrier;
means for customizing said label with a customized display;
a printer to print said customized display on said label; and
a label applicator that facilitates alignment of said label with said indicia carrier for joining said label and said indicia carrier.

2. The system of claim 1, further comprising a heat source that applies heat to one of said label and said indicia carrier to improve adhesion of said label to said indicia carrier.

3. The system of claim 1, further comprising an abrader that abrades at least a portion of a surface of said indicia carrier to improve adhesion of said label to said indicia carrier.

4. A method for facilitating the creation of a customized gift card, comprising:
making available a indicia carrier having a machine readable medium for an encoded account number supported on one side of the indicia carrier and being devoid of indicia formed from the indicia carrier;
making available a label to be applied to said indicia carrier;
facilitating customization of said label to comprise a customized display;
facilitating printing of said customized display on said label; and
facilitating application of said label to said indicia carrier.

5. The method of claim 4, wherein making available a indicia carrier occurs at a point of sale, making available a label occurs at said point of sale, facilitating customizing of the label occurs at said point of sale, facilitating printing occurs at said point of sale, and facilitating application of said label to said indicia carrier occurs at said point of sale.

6. The method of claim 4, wherein said facilitating application of said label further comprises facilitating alignment of said label with said indicia carrier during said application of said label to said indicia carrier.

7. The method of claim 6, wherein said facilitating alignment comprises providing a label applicator having a guide wall for aligning an edge of said indicia carrier and an edge of said label to facilitate proper placement of said label on said indicia carrier.

8. The method of claim 7, further comprising disposing said label in said label applicator with an adhesive side of said label at least partially exposed, and disposing said indicia carrier in said label applicator to contact said adhesive side of said label.

9. The method of claim 6, further comprising applying heat to at least one of said label and said indicia carrier to improve adhesion of said label to said indicia carrier.

10. The method of claim 6, further comprising abrading at least a portion of a surface of said indicia carrier prior to receiving said label to improve adhesion of said label to said surface of said indicia carrier.

11. The method of claim 4, wherein said facilitating customization of said label comprises providing network access to stored data, wherein said data may be retrieved to create at least a part of said customized image.

12. The method of claim 11, wherein said data is stored on and retrieved from an internet accessible database.

13. A method for creating a customized gift card, comprising:
obtaining an indicia carrier having a machine readable medium for an encoded account number supported on one side of the indicia carrier and being devoid of indicia formed from the indicia carrier;
customizing a display for said indicia carrier;
printing said display on a label; and
joining said label to said indicia carrier.

14. The method of claim 13, wherein obtaining an indicia carrier, customizing a display, printing said display on a label, and joining said label to said indicia carrier occurs at said point of sale.

15. The method of claim 13, wherein joining said label to said indicia carrier is facilitated by utilizing a label applicator, wherein said label is disposed in said label applicator with an adhesive side at least partially exposed, and wherein said indicia carrier is subsequently disposed in said label applicator to contact said adhesive side of said label.

16. The method of claim 15, further comprising applying heat to at least one of said label and said indicia carrier to improve adhesion of said label to said indicia carrier.

17. The method of claim 15, further comprising abrading at least a portion of a surface of said indicia carrier prior to receiving said label to improve adhesion of said label to said surface of said indicia carrier.

18. The method of claim 17, wherein said applicator has supported thereon an abrader that is used for abrading the surface of said indicia carrier.

19. The method of claim 13, wherein customizing a display for said indicia carrier comprises retrieving stored data from an internet accessible database.

20. The method of claim 13, wherein obtaining an indicia carrier, customizing a display, printing said display on a label, and joining said label to said indicia carrier occur at a combination of locations selected from the group consisting of a point of sale, and a post point of sale location.
